(19) United States
(12) Patent Application Publication
(10) Pub. No.: US 2012/0073463 A1
(43) Pub. Date: Mar. 29, 2012

(54) Hook to Fabric Fastener Closure Tool

(75) Inventor: Howard W. DeMoore, Dallas, TX (US)

(73) Assignee: PRINTING RESEARCH, INC., Dallas, TX (US)

(21) Appl. No.: 12/890,393

(22) Filed: Sep. 24, 2010

(51) Int. Cl. B41F 13/20; B25B 27/14

(52) U.S. Cl. 101/479; 29/270

(57) ABSTRACT

In a printing press having a transfer cylinder for transferring a freshly printed substrate, a method of preparing the printing press for printing is provided. The method comprises placing a first edge of a flexible jacket over one of a hook type attachment structure or a loop type attachment structure coupled to a first edge of the transfer cylinder and pressing the flexible jacket into contact with the hook type attachment structure or the loop type attachment structure, wherein the pressing is performed by surface contact between the flexible jacket and a loop type material attached to a tool.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In the operation of a rotary offset printing press, freshly printed substrates, such as sheets or web material, are guided by transfer cylinders or the like from one printing unit to another, and then they are delivered to a sheet stacker or to a sheet folder/cutter unit, respectively. As used herein, the term “transfer cylinder” includes delivery cylinders, transfer rollers, support rollers, support cylinders, delivery wheels, skeleton wheels, segmented wheels, transfer drums, support drums, spider wheels, support wheels, guide wheels, guide rollers, and the like. Ink marking problems inherent in transferring freshly printed substrates have been longstanding.

That system, which is marketed under license by Printing Research, Inc. of Dallas, Tex., U.S.A. under the registered trademark SUPER BLUE® includes the use of a low friction coating or coated material on the supporting surface of the transfer cylinder, and over which is loosely attached a movable fabric covering. The fabric covering provided a yieldable, cushioning support for the freshly printed side of the substrate such that relative movement between the freshly printed substrate and the transfer cylinder surface would take place between the fabric covering and the support surface of the transfer cylinder so that marking and smearing of the freshly printed surface was substantially reduced. Various improvements have been made to the SUPER BLUE® system, which are described in more detail in U.S. Pat. Nos. 5,907,998 and 6,244,178 each entitled “Anti-Static, Anti-Smearing Pre-Stretched and Pressed Flat, Precision-Cut Striped Flexible Coverings for Transfer Cylinders”; U.S. Pat. Nos. 5,511,480, 5,603,264, 6,073,556, 6,119,597, and 6,192,800 each entitled “Method and Apparatus for Handling Printed Sheet Material”; U.S. Pat. No. 5,979,322 entitled “Environmentally Safe, Ink Repellent, Anti-Marking Flexible Jacket Covering Having Alignment Stripes, Centering Marks and Pre-Fabricated Reinforcement Strips for Attachment onto Transfer Cylinders in a Printing Press”; U.S. Pat. No. RE39,305 entitled “Anti-static, Anti-smearing Pre-stretched and Pressed Flat, Precision-cut Striped Flexible Coverings for Transfer Cylinders”; U.S. patent application Ser. No. 12/343,481 entitled “Anti-marking Jackets Comprised of Fluoropolymer and Methods of Using in Offset Printing,” by Howard W DeMoore, et al., filed Dec. 24, 2008; and U.S. patent application Ser. No. 12/832,803 entitled “Anti-marking Jackets Comprised of Attachment Structure and Methods of Using in Offset Printing,” by Howard W. DeMoore, filed Jul. 8, 2010, each of which is hereby incorporated by reference herein in its entirety. The above cited patents and patent applications are all owned by Printing Research, Inc. of Dallas, Tex., U.S.A.

### SUMMARY

In an embodiment, in a printing press having a transfer cylinder for transferring a freshly printed substrate, a method of preparing the printing press for printing is disclosed. The method comprises placing a first edge of a flexible jacket over one of a hook type attachment structure or a loop type attachment structure coupled to a first edge of the transfer cylinder and pressing the flexible jacket into contact with the hook type attachment structure or the loop type attachment structure, wherein the pressing is performed by surface contact between the flexible jacket and a loop type material attached to a tool.

In an embodiment, a handled tool for mating hook type material to another material is disclosed. The handled tool comprises a handle, a cylinder coupled to the handle, and a loop type material coupled to an outer circumferential surface of the cylinder.

In an embodiment, in a printing press having a transfer cylinder for transferring a freshly printed substrate, a method of preparing the printing press for printing is disclosed. The method comprises placing a first edge of a flexible jacket over a hook type attachment structure coupled to a base cover, pressing the flexible jacket into contact with the hook type attachment structure, wherein the pressing is performed by surface contact between the flexible jacket and a loop type material attached to a handled tool, and coupling the base cover to the transfer cylinder.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a view of a transfer cylinder and a flexible jacket according to an embodiment of the disclosure.

FIG. 2A is a view of a handled tool according to an embodiment of the disclosure.

FIG. 2B is a view of a handled tool according to an embodiment of the disclosure.

FIG. 3 is a flow chart of a method according to an embodiment of the disclosure.

FIG. 4 is a flow chart of a method according to an embodiment of the disclosure.

FIG. 5A is a schematic side elevational view showing multiple transfer cylinders installed at substrate transfer positions in a four color rotary offset printing press of a type made by Heidelberg Druckmaschinen Aktiengesellschaft.

FIG. 5B is a schematic side elevational view showing multiple transfer cylinders installed at substrate transfer positions in a four color rotary offset printing press of the Lithrone Series made by Komori Corp.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In an embodiment, a transfer cylinder of a printing press may be at least partially enclosed by a flexible jacket installed over the transfer cylinder and/or over an optional base cover coupled to the transfer cylinder. The flexible jacket may be made of a variety of materials, including a cotton fabric, a woven cotton fabric, and/or a woven fluoropolymer fabric. The flexible jacket may be coupled to the transfer cylinder by one or more strips of hook type attachment material that grabs the woven fabric of the flexible jacket. The present disclosure teaches a tool for mating the hook type material to the flexible jacket. The tool may take a variety of forms, but in an embodiment, the tool comprises a roller coupled to the tool so as to rotate about a central axis of the roller. An outer surface of the roller is at least partially enclosed and/or covered with a loop type material. By pressing the roller onto a flexible jacket laid over a strip of hook type material and rolling the roller back and forth over the flexible jacket where it is laid over the strip of hook type material, the hooks of the hook type material may be mated with the flexible jacket. For example, some of the hooks may pass through the surface of the flexible jacket and grab the fabric of the flexible jacket. The tool may comprise a handle for grasping and manipulating the tool. It has been found that the tool promotes improved penetration of the flexible jacket by the hooks, resulting in a more secure coupling of the flexible jacket to the strip of hook type material.

In an alternative embodiment, the tool comprises a handle for grasping and manipulating the tool and an area covered with a loop type material. By pressing the area onto a flexible jacket laid over a strip of hook type material and sliding the area over the flexible jacket where it is laid over the strip of hook type material while continuing to press the area onto the flexible jacket, some of the hooks may pass through the surface of the flexible jacket and grab the fabric of the flexible jacket. The area may be a flat area that is held at a fixed angle relative to the handle. The area may be a flat area that is coupled to the handle at a pivot point that may be able to rotate at least partially about an axis defined by the pivot point. The area may be semi-cylindrical in shape or bowed.

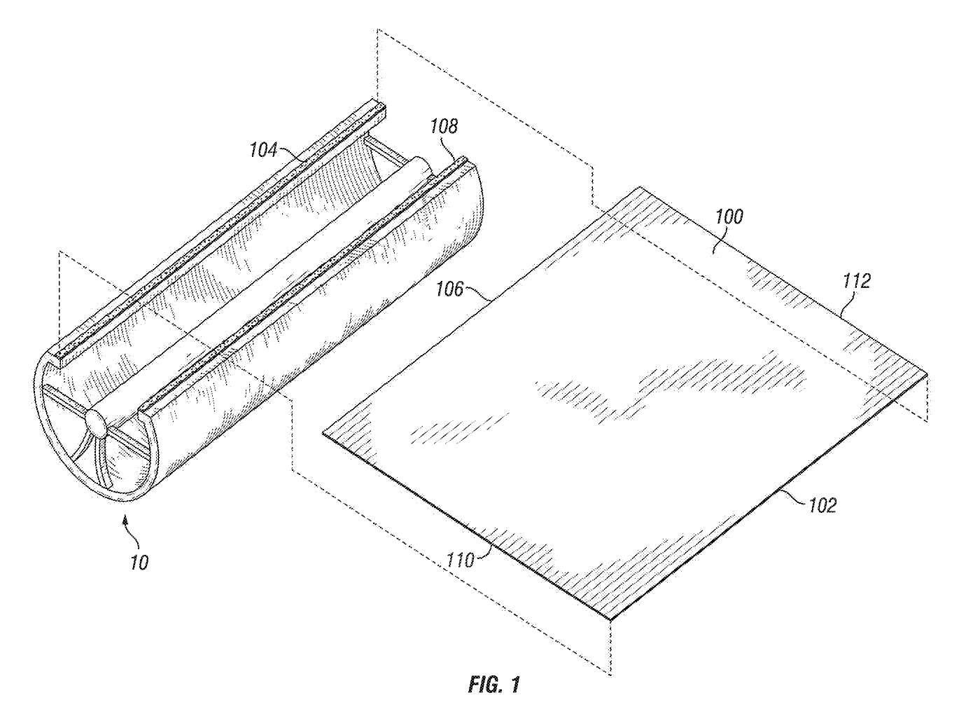

Turning now to FIG. 1, attachment of a flexible jacket 100 to a transfer cylinder 10 of a printing press is described. A first edge 102 of the flexible jacket 100 may be coupled to a first attachment structure 104 coupled to the transfer cylinder 10. The flexible jacket 100 may be wrapped around an outside surface of the transfer cylinder 10, and a second edge 106 of the flexible jacket 100 may be coupled to a second attachment structure 108 coupled to the transfer cylinder 10. The attachment structures 104, 108 may be coupled directly to the transfer cylinder 10. Alternatively, the attachment structures 104, 108 may be coupled to a base cover, wherein the base cover is coupled to the transfer cylinder 10. The attachment structures 104, 108 may comprise hook type material that captures and/or mates with the fabric of which the flexible jacket 100 is comprised. Alternatively, the flexible jacket 100 may have loop type attachment structures coupled to the flexible jacket at the first edge 102 and/or the second edge 106 that mate with the hook type material of the attachment structures 104, 108. In some contexts, the edge of the transfer cylinder 10 proximate to the first attachment structure 104 may be referred to as a gripper edge of the transfer cylinder 10 and the edge of the transfer cylinder proximate to the second attachment structure 108 may be referred to as a tail edge of the transfer cylinder 10. In an embodiment, a third edge 110 and a fourth edge 112 of the flexible jacket 100 may likewise be coupled to attachment structures coupled to the outer rims of the transfer cylinder 10.

The flexible jacket 100 may be coupled to the transfer cylinder 10 with an effective amount of free play or end play for promoting anti-marking operation of the printing press. In some contexts, the flexible jacket 100 may be referred to as a net or as an anti-marking jacket. The flexible jacket 100 may be made of a wide variety of materials including, but not limited to, material comprising cotton, for example a woven cotton fabric, and a material comprising fluoropolymer, for example a fabric coated with fluoropolymer and/or a material woven of fluoropolymer threads. In an embodiment, a plurality of flexible jackets 100 may be installed over the transfer cylinder 10 with no intervening base cover, the plurality of flexible jackets 100 being installed with an amount of free play that is effective to promote anti-marking operation of the printing press. The plurality of flexible jackets 100 may be permanently or semi-permanently attached to each other, for example by stitching.

When the printing press is operated, freshly printed substrates are supported by the flexible jackets 100 installed over the transfer cylinders 10 as the substrates are transferred from station to station within the printing press and finally distributed out of the printing press to a stacking apparatus. In an embodiment, it is thought that the free play of the flexible jacket 100 promotes the flexible jacket 100 expanding when the transfer cylinder 10 rotates, providing a yieldable, cushioning support for the freshly printed substrates and allowing the flexible jacket 100 to adhere to the freshly printed substrates. Further, it is thought that the free play of the flexible jacket 100 promotes the flexible jacket 100 moving with the printed substrate, thereby avoiding marking the freshly printed substrate with spurious inking and/or smearing the ink on the freshly printed substrate. The structures of printing presses and transfer cylinders 10 are well known.

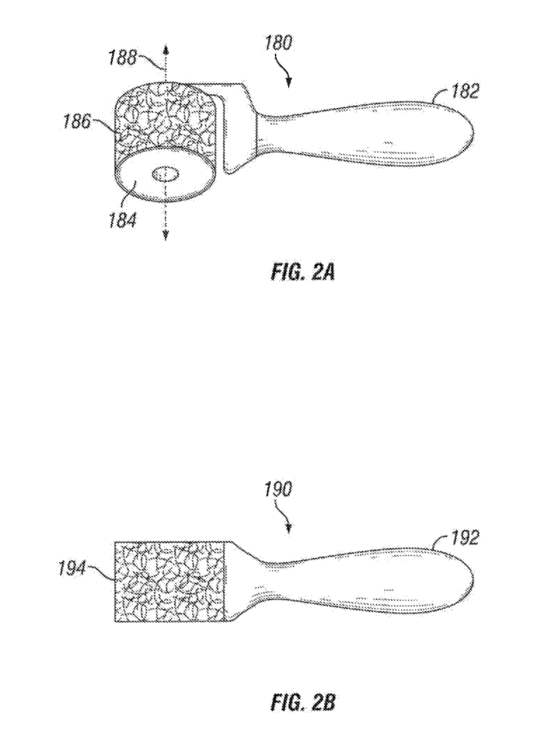

Turning now to FIG. 2A, a first tool 180 is described. The first tool 180 comprises a handle 182, a roller 184, and a loop type material 186. The loop type material 186 at least partially covers the outside surface of the roller 184. The loop type material 186 may be cut from a strip of loop type material to have a length that substantially corresponds to a circumference of the roller 184 and adhered to the outside surface of the roller 184. In an embodiment, the roller 184 may be coupled to the handle 182 in a way that leaves the roller 184 free to rotate about a central axis 188 of the roller 184. In some contexts, the central axis 188 of the roller 184 may be referred to as an axis of symmetry. Alternatively, in another embodiment, the roller 184 may be coupled to the handle 182 in a way that prevents the roller 184 from rotating. The roller 184 may be coupled to the handle 182 in a way that allows the roller 184 to be relocated to and then fixed at a plurality of different rotational positions, for example to distribute wear patterns over the loop type material 186.

The loop type material 186 may be said to be napped. The loops of the loop type material 186 may be randomly oriented rather than substantially all oriented parallel to each other. In an embodiment, the loop type material 186 may be said to have high pile. In an embodiment, the loop type material 186 may be VELCRO Loop 1000 type material. While the central axis 188 of the roller 184 in FIG. 2A is shown as substantially perpendicular to an axis of the handle 182, in another embodiment the central axis 188 of the roller 184 may be substantially parallel to the axis of the handle 182. Alternatively, the central axis 188 of the roller 184 may make some other angle with the axis of the handle 182.

A user may grip the handle 182, apply pressure onto the roller 184, and roll the roller 184 over the flexible jacket 100 where it overlaps an attachment structure coupled to the transfer cylinder 10, for example rolling the roller 184 over the first edge 102 of the flexible jacket 100 while it is laying over the first attachment structure 104 coupled to the transfer cylinder 10. It has been found that the use of a tool similar to first tool 180 promotes improved mating of the hook type attachment structure to the flexible jacket 100 and/or with a corresponding loop type material 186. When using different hook type attachment structures, for example different hook type material featuring different sized hooks, it may be desirable to use different loop type material 186 on the roller 184, for example loop type material 186 sized to mate with the corresponding size of the hooks. It has been found that a roller 184 having a smooth surface (e.g., lacking the loop type material 186) is less effective in mating of the hook type attachment structure to the flexible jacket 100 and/or to a corresponding loop type material 186 than a roller 184 having the loop type material 186.

Not wishing to be bound by theory, it is thought that the loop type material 186 has a surface having areas of increased relative density of loops alternating with areas of decreased relative density of loops that promote the hooks in the hook type attachment structures 104, 108 penetrating the flexible jacket 100 to hook and attach to the flexible jacket 100 more securely. Where an area of decreased relative density of loops is rolled over the flexible jacket 100, the hooks in the hook type attachment structures 104, 108 may more readily penetrate the portion of the flexible jacket 100 that is engaged by that area of decreased relative density of loops, because the area of decreased relative density of loops may present less resistance to the hooks. Where an area of increased relative density of loops is rolled over the flexible jacket 100, the hooks of the hook type attachment structures 104, 108 may penetrate the flexible jacket 100 less readily and may couple to the portion of the flexible jacket 100 that is engaged by that area of increased relative density of loops with only the moderate security achieved using earlier methods, for example pressing with fingers or thumbs. The net result, however, is an increased overall security of coupling between the hook type attachment structures 104, 108 and the flexible jacket 100 due at least to the areas of decreased relative density of loops on the surface of the loop type material 186.

Further, it is possible that by rolling the loop type material 186 back and forth over the hook type attachment structures 104, 108, different areas of the loop type material 186 may engage with a subject area of the flexible jacket 100. For example, on a first pass of the loop type material 186 rolling over the flexible jacket 100, an area of increased relative density may engage with a subject area of the flexible jacket 100 and consequently the subject area of the flexible jacket 100 may be coupled to the hook type attachment structures 104, 108 with moderate security. On a second pass of the loop type material 186 rolling over the flexible jacket 100, an area of decreased relative density may engage with the subject area of the flexible jacket 100 and consequently the subject area of the flexible jacket 100 may be coupled to the hook type attachment structures 104, 108 with enhanced security. A variety of causes may lead to different areas of the loop type material 186 engaging the subject area of the flexible jacket 100 on different passes: the roller 184 may not be rolled over exactly the same path during each pass, the roller 184 may slip or slide over the flexible jacket 100 while rolling over the flexible jacket 100.

While in a preferred embodiment, the first tool 180 comprises a roller 184 at least partially covered by loop type material 186, it is contemplated that another structure may be used to accomplish increased security of coupling between the flexible jacket 100 and the hook type attachment structures 104, 108. For example, a roller 184 having a surface with areas of increased outside diameter alternating with areas of decreased outside diameter may promote increased security of coupling of the hook type attachment structures 104, 108 to the flexible jacket 100. In some contexts the areas of increased outside diameter may be referred to as peaks and the areas of decreased outside diameter may be referred to as valleys. The valley areas of the surface of the roller 184 may promote increased penetration of hooks of the hook type attachment structures 104, 108 into the flexible jacket 100 in much the same way that the areas of decreased relative density of loops of the loop type material 186 described above. The surface of the roller 184 may be ridged. The surface of the roller 184 may have a herringbone pattern. The surface of the roller 184 may have a plurality of holes.

Some flexible jackets 100 and/or portions of flexible jackets 100 may be relatively more difficult to couple to the hook type attachment structures 104, 108. For example, flexible jackets 100 having a relatively denser weave and/or flexible jackets 100 comprised of fluoropolymer material may be less amenable to penetration and/or gripping by the hooks of the hook type attachment structures 104, 108. Likewise, a selvage edge of the flexible jacket 100 may be less amenable to penetration and/or gripping by the hooks of the hook type attachment structures 104, 108. The increased security of coupling between the hook type attachment structures 104, 108 and the flexible jacket 100 that is promoted by the first tool 180 may be particularly useful when the flexible jacket 100 has a denser weave, when the flexible jacket 100 is comprised of fluoropolymer, and/or when coupling to a selvage edge of the flexible jacket 100.

Turning now to FIG. 2B, a second tool 190 is described. The second tool 190 comprises a handle 192 and an area of loop type material 194 disposed on an end of the second tool 190 opposite the handle 192. The loop type material 194 may be substantially similar to the loop type material 186 described above with reference to FIG. 2A. The loop type material 194 may be adhered to a substantially flat area located on a fixed part of the tool 190. Alternatively, the loop type material 194 may be adhered to a rounded or curved area located on a fixed part of the tool 190. Alternatively, the loop type material 194 may be adhered to either a flat area or a curved area located on a portion of the tool 190 that is coupled to the handle 192 by a pivot, such that the flat area or curved area are moveable with reference to the handle 192.

A user may grip the handle 192, apply pressure onto the loop type material 194, and slide and/or drag it over the flexible jacket 100 where it overlaps an attachment structure coupled to the transfer cylinder 10, for example sliding the loop type material 194 over the first edge 102 of the flexible jacket 100 while it is laying over the first attachment structure 104 coupled to the transfer cylinder.

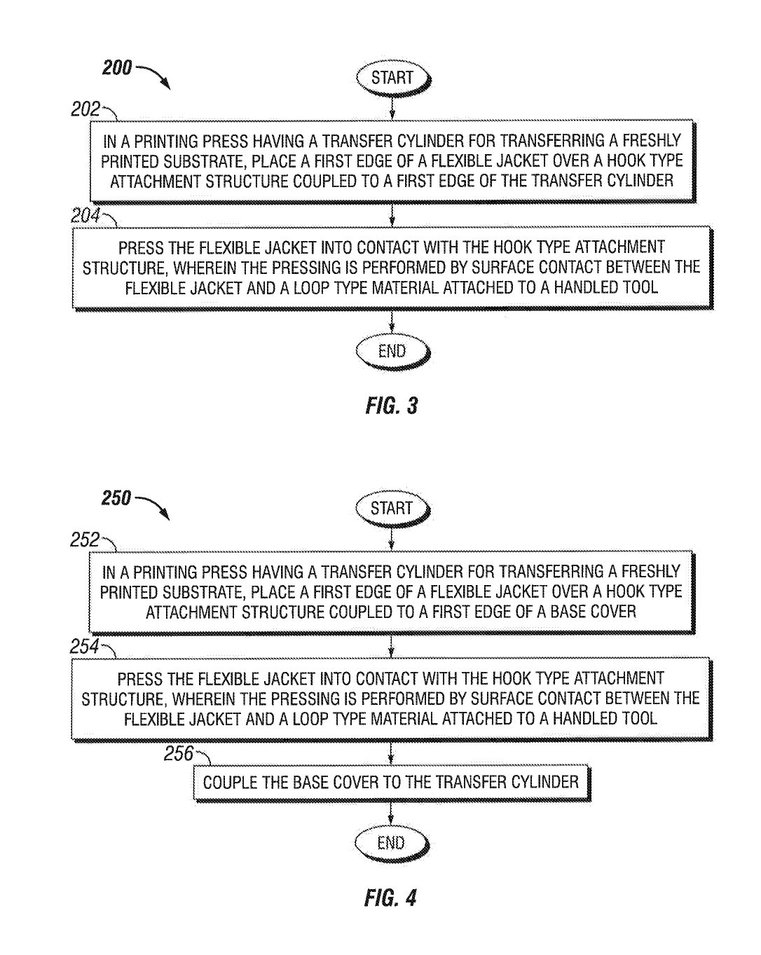

Turning now to FIG. 3, a method 200 is described. At block 202, in a printing press having a transfer cylinder for transferring a freshly printed substrate, place a first edge of a flexible jacket over a hook type attachment structure coupled to a first edge of the transfer cylinder. For example, place the first edge 102 of the flexible jacket 100 over the first attachment structure 104 coupled to the transfer cylinder 10. At block 204, press the flexible jacket into contact with the hook type attachment structure, wherein the pressing is performed by surface contact between the flexible jacket and a loop type material attached to a handled tool. For example, press the first edge 102 of the flexible jacket 100 into contact with the first attachment structure 104 by rolling the roller 184 over the first edge 102 while maintaining pressure on the roller 184 via force applied to the handle 182. Alternatively, press the first edge 102 of the flexible jacket 100 into contact with the first attachment structure 104 by sliding the loop type material 194 coupled to the second tool 190 while maintaining pressure on the loop type material 194 via force applied to the handle 192.

It may be preferred to couple the flexible jacket 100 to the first attachment structure 104 first beginning at a middle portion of the first attachment structure 104 and work progressively out towards the ends of the first attachment structure 104, adjusting the positioning of the flexible jacket 100 relative to the first attachment structure 104 to maintain desired alignment and/or straightness of the flexible jacket 100 relative to the transfer cylinder 10. For example, the roller 184 may be rolled over the flexible jacket 100 at a middle portion, moving in small rolling motions along the first edge 102. The position of the flexible jacket 100 may be adjusted to align properly with the transfer cylinder 10, and the roller 184 may be rolled in slightly extended rolling motions along the first edge 102. This process may be continued, adjusting the alignment of the flexible jacket 100 and then rolling out in progressively longer paths until the flexible jacket 100 is coupled along substantially the entire length of the first attachment structure 104. It is understood that the method 200 may be applied to couple other attachment structures coupled to the transfer cylinder 10 to the flexible jacket 100, for example the second attachment structure 108 and/or other attachment structures coupled to the transfer cylinder 10. In an embodiment, as the flexible jacket 100 is coupled to the second attachment structure 108, the positioning of the flexible jacket 100 may further be adjusted to provide a desired amount of looseness and/or free play of the flexible jacket 100. In an embodiment, under some circumstances the handle 182, 192 of the tool 180, 190 may be used to couple the flexible jacket 100 to the attachment structures 104, 108, for expel by rubbing the handle 182, 192 onto the flexible jacket 100.

Alternatively, in an embodiment, an adjustment tool may be used while attaching the flexible jacket 100 to the second attachment structure 108 tautly and/or without free play, such that after the removal of the adjustment tool the flexible jacket 100 is attached with the desired amount of looseness and/or free play. For further details about an adjustment tool promoting installation of the flexible jacket 100 with looseness and/or free play, see U.S. patent application Ser. No. 12/874,154, entitled “Apparatus and Method for Adjusting Anti-marking Jackets,” by Howard W. DeMoore, filed Sep. 1, 2010, which is hereby incorporated by reference.

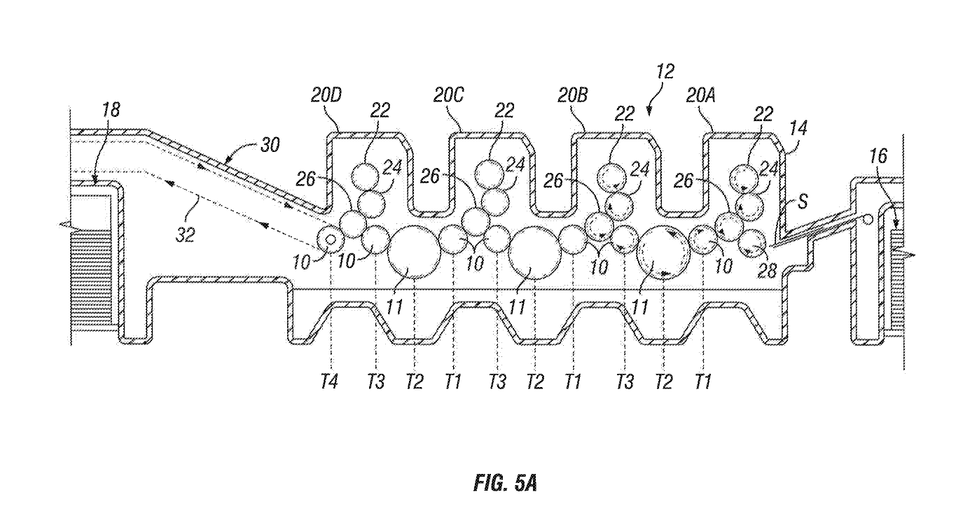

Turning now to FIG. 4, a method 250 is described. At block 252, in a printing press having a transfer cylinder for transferring a freshly printed substrate, place a first edge of a flexible jacket over a hook type attachment structure coupled to a first edge of base cover. At block 254, press the flexible jacket into contact with the hook type attachment structure, wherein the pressing is performed by surface contact between the flexible jacket and a loop type material attached to a handled tool. It is understood that either of tools 180 and 190 may be used to perform the activity of block 254. At block 256, couple the base cover to the transfer cylinder. It is understood that in some circumstances the base cover may be coupled to the transfer cylinder 10 before the method 250 is performed, and in this circumstance block 256 need not be performed. While the processing of methods 200 and 250 describe the use of the tool 180, 190 to couple a flexible jacket 100 to a transfer cylinder 10, it is understood that the tool 180, 190 may be used to couple hook attachment structures to loop attachment structures in other contexts that may not be associated with printing presses, for example for mating corresponding hook and loop attachment structures to each other.

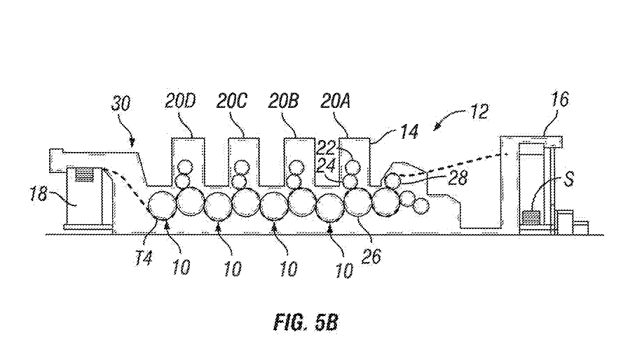

Referring to FIG. 5A and FIG. 5B, two representative presses are now described. A press 12 includes a press frame 14 coupled on its input end to a sheet feeder 16 from which sheets, herein designated S, are individually and sequentially fed into the press 12. At its delivery end, the press 12 is coupled to a sheet stacker 18 in which the printed sheets are collected and stacked. Interposed between the sheet feeder 16 and the sheet stacker 18 are four substantially identical sheet printing units 20A, 20B, 20C, and 20D which are capable of printing different color inks onto the sheets as they are transferred through the press.

As illustrated in FIG. 5A and FIG. 5B, each printing press 12 is of conventional design, and includes a plate cylinder 22, a blanket cylinder 24, and an impression cylinder 26. Freshly printed sheets S from the impression cylinder 26 are transferred to the next printing unit by a transfer cylinder 10 or a plurality of transfer cylinders 10. The initial sheet printing unit 20A is equipped with a sheet in-feed roller 28 which feeds individual sheets one at a time from the sheet feeder 16 to the initial impression cylinder 26.

The freshly printed sheets S are transferred to the sheet stacker 18 by a delivery conveyor system, generally designated 30. The delivery conveyor system 30 is of conventional design and includes a pair of endless delivery gripper chains 32 carrying transversely disposed gripper bars, each having gripper elements for gripping the leading edge of a freshly printed sheet S as it leaves the impression cylinder 26 at the delivery position T4. As the leading edge of the printed sheet S is gripped by the grippers, the delivery gripper chains 32 pull the gripper bars and sheet S away from the impression cylinder 26 and transport the freshly printed sheet S to the sheet delivery stacker 18.

Referring to FIG. 5A, an intermediate transfer cylinder 11 receives sheets printed on one side from the transfer cylinder 10 of the preceding printing unit 20. Each intermediate transfer cylinder 11, which is of conventional design, typically has a diameter twice that of the transfer cylinder 10, and is located between two transfer cylinders 10, at interstation transfer positions T1, T2 and T3, respectively. The impression cylinders 26, the intermediate transfer cylinders 11, the transfer cylinders 10, as well as the sheet in-feed roller 28, are each provided with sheet grippers which grip the leading edge of the sheet to pull the sheet around the cylinder in the direction as indicated by the associated arrows. The transfer cylinder 10 in the delivery position T4 is not equipped with grippers, and includes instead a large longitudinal opening A, which provides clearance for passage of the chain driven delivery conveyor gripper bars. In some printing press installations, an artificial radiation source, for example an ultraviolet lamp and/or an infrared lamp, may be mounted to radiate semi-directly or directly onto the interstation transfer positions T1, T2, and T3. The artificial radiation may be employed to cure and/or set the wet ink on printed substrates as they pass through the printing press.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What we claim is:

1. In a printing press having a transfer cylinder for transferring a freshly printed substrate, a method of preparing the printing press for printing, comprising:
placing a first edge of a flexible jacket over one of a hook type attachment structure or a loop type attachment structure coupled to a first edge of the transfer cylinder; and
pressing the flexible jacket into contact with the hook type attachment structure or the loop type attachment structure, wherein the pressing is performed by surface contact between the flexible jacket and a loop type material attached to a tool.

2. The method of claim 1, wherein the tool is a handled tool.

3. The method of claim 2, wherein the loop type material attached to the tool is coupled in a substantially stationary mode to the handled tool at an end opposite to a handle and wherein pressing the flexible jacket into contact with the hook type attachment structure or the loop type attachment structure comprises pressing the loop type material on the flexible jacket while dragging the loop type material attached to the tool across the first edge of the flexible jacket.

4. The method of claim 2, wherein the loop type material attached to the tool is coupled to a roller coupled to the handled tool and wherein pressing the flexible jacket into contact with the hook type attachment structure or the loop type attachment structure comprises pressing the roller portion of the handled tool on the flexible jacket while rolling the roller portion along the first edge of the flexible jacket.

5. The method of claim 1, wherein the flexible jacket is formed of at least one of cotton or fluoropolymer.

6. The method of claim 1, wherein one of a loop type attachment structure and a hook type attachment structure is coupled to the first edge of the flexible jacket, wherein pressing the flexible jacket into contact with the hook type attachment structure coupled to the first edge of the transfer cylinder comprises pressing the loop type attachment structure coupled to the first edge of the flexible jacket into contact with the hook type attachment structure coupled to the first edge of the transfer cylinder, and wherein pressing the flexible jacket into contact with the loop type attachment structure coupled to the first edge of the transfer cylinder comprises pressing the hook type attachment structure coupled to the first edge of the flexible jacket into contact with the loop type attachment structure coupled to the first edge of the transfer cylinder.

7. A handled tool for mating hook type material to another material, comprising:
a handle;
a cylinder coupled to the handle; and
loop type material coupled to an outer circumferential surface of the cylinder.

8. The tool of claim 7, wherein a central axis of the cylinder is substantially orthogonal to an axis of the handle.

9. The tool of claim 7, wherein a central axis of the cylinder is substantially parallel to an axis of the handle.

10. The tool of claim 7, wherein the loop type material is adhered to the outer circumferential surface of the cylinder.

11. The tool of claim 7, wherein the cylinder is free to rotate about a central axis of the cylinder when coupled to the handle.

12. The tool of claim 7, wherein the cylinder is prevented from rotating about a central axis of the cylinder when coupled to the handle.

13. In a printing press having a transfer cylinder for transferring a freshly printed substrate, a method of preparing the printing press for printing, comprising:
placing a first edge of a flexible jacket over a hook type attachment structure coupled to a base cover;
pressing the flexible jacket into contact with the hook type attachment structure, wherein the pressing is performed by surface contact between the flexible jacket and a loop type material attached to a handled tool; and
coupling the base cover to the transfer cylinder.

14. The method of claim 13, wherein the loop type material is coupled in a substantially stationary mode to the handled tool at an end opposite to a handle and wherein pressing the flexible jacket into contact with the hook type attachment structure comprises pressing the loop type material on the flexible jacket while dragging the loop type material across the first edge of the flexible jacket.

15. The method of claim 13, wherein the loop type material is coupled to a roller coupled to the handled tool and wherein pressing the flexible jacket into contact with the hook type attachment structure comprises pressing the roller portion of the handled tool on the flexible jacket while rolling the roller portion along the first edge of the flexible jacket.

16. The method of claim 13, wherein the flexible jacket is formed of cotton.

17. The method of claim 13, wherein a loop type attachment structure is coupled to the first edge of the flexible jacket, wherein pressing the flexible jacket into contact with the hook type attachment structure comprises pressing the loop type attachment structure into contact with the hook type attachment structure.

18. The method of claim 17, wherein the flexible jacket comprises fluoropolymer.

19. The method of claim 13, wherein the flexible jacket comprises a film material or a woven material.

20. The method of claim 19, wherein one of ceramic beads and glass beads are coupled to the film material.
